(19) United States
(12) Patent Application Publication
(10) Pub. No.: US 2014/0367073 A1
(43) Pub. Date: Dec. 18, 2014

(54) LIQUID TRANSPORT MEMBRANE

(71) Applicant: Osmotex AG, Alpnach Dorf (CH)

(72) Inventors: Trond Heldal, Luzern (CH); Dominique Lauper, Nidau (CH)

(73) Assignee: OSMOTEX AG, Alpnach Dorf (CH)

(21) Appl. No.: 14/367,119

(22) PCT Filed: Dec. 20, 2012
(86) PCT No.: PCT/EP2012/076527

§ 371 Date: Jun. 19, 2014

(30) Foreign Application Priority Data
Dec. 20, 2011 (EP) 11194642.2

(51) Int. Cl. F24F 5/00; B01D 61/42

(52) U.S. Cl. CPC F24F 5/0035; B01D 61/427
USPC 165/104.23; 62/315; 204/600

(57) ABSTRACT

A cooling device includes an electroosmotic liquid transport membrane and a passage through which a fluid to be cooled can flow. The passage has a wall which includes the electroosmotic liquid transport membrane. The membrane is arranged to transport liquid to effect evaporative cooling such that the fluid in the passage can be cooled. The fluid in the passage is a liquid and the cooling device is arranged so that in use, the liquid being transported to effect evaporative cooling is transported through the electroosmotic liquid transport membrane out of the passage.

### FIELD OF THE INVENTION

Embodiments of the present invention relate to membranes exhibiting favourable liquid transport properties, and to several applications of liquid transport membranes.

### DESCRIPTION OF RELATED ART

In general, humidity control represents a challenge in all applications involving water in the form of condensation, perspiration, rain, percolation, process water, and so on.

The human body, particularly during physical activity, exudes perspiration that should be carried away from the skin in order to ensure thermal comfort. Many textiles, in particular those suitable for waterproof and protective garments, have however little abilities to transport humidity, and can therefore lead to overheating or heat losses when humidity saturates the fibres of a garment and reduce its thermal insulation.

Modern pieces of clothing make use of so called ‘breathable’ fabrics that allow the passage of water vapour while remaining waterproof. Such materials, relying on passive transport of water and their effectiveness reduces with the increase of the external humidity.

It has been proposed to exploit the phenomena of electroosmosis or other electrokinetic effects to actively transport water through a membrane, even against a pressure gradient or a concentration gradient. A piece of porous material is sandwiched between two conductive electrodes that are connected to a suitable energy source. The electric field in the porous layer induces motion of the fluid within the textile, effectively pumping it from one side of the membrane to the other.

### BRIEF SUMMARY OF THE INVENTION

According to the invention, these aims are achieved by means of the object of the appended claims.

In a first aspect the present invention provides a cooling device, wherein the cooling device comprises: an electroosmotic liquid transport membrane, and a passage through which a fluid to be cooled can flow, wherein the electroosmotic liquid transport membrane is arranged to transport liquid to effect evaporative cooling such that the fluid in the passage can be cooled.

This arrangement means that evaporative cooling can be used to cool a fluid that then may be used to effect cooling in applications such as cooling buildings. Water transported through the electroosmotic liquid transport membrane may evaporate from the surface of the electroosmotic liquid transport membrane which cools the electroosmotic liquid transport membrane and the surrounding parts (including the passage through which a fluid to be cooled can flow thus cooling the fluid therein). The fluid to be cooled may be a liquid, such as water, or a gas, such as air or a combination of both.

The electroosmotic liquid transport membrane may be in thermal contact with the passage through which the fluid to be cooled can flow. This means that evaporative cooling on the surface of the electroosmotic liquid transport membrane can cool the fluid in the passage, i.e. by thermal contact it is meant that the parts are in communication such that heat transfer can occur between the parts (a cooling of the electroosmotic liquid transport membrane results in cooling of the fluid in the passage) and not necessarily in direct contact.

The electroosmotic liquid transport membrane may be a membrane comprising first and second conductive layers, and at least one porous layer positioned between the first and second conductive layers. In use, a voltage is applied between the first and second conductive layers to generate an electric field whereby a current passes between the conductive layers so as to induce liquid transport across the membrane. Preferably, the device comprises a power source to apply a voltage between the first and second conductive layers. The first and second conductive layers are preferably porous.

The evaporative cooling achieved can be controlled by controlling the transport of liquid through the electroosmotic liquid transport membrane. The device preferably comprises a control means for controlling the liquid transport through the membrane, such as by controlling a voltage applied between the first and second conductive layers. If the amount of evaporative cooling required is larger more liquid can be transported through the membrane. If the amount of evaporative cooling required is less, less liquid can be transported through the membrane. If evaporative cooling is not required at a given time, the induction of transport of liquid through the electroosmotic liquid transport membrane can be stopped.

The device may comprise a sensor, such as a temperature sensor, the output of which can be used to control the transport of liquid, such as the rate of liquid transport, through the electroosmotic liquid transport membrane. For example, the temperature sensor may measure the temperature of the fluid in the passage and, based on the output from the sensor, the transport of liquid through the electroosmotic liquid transport membrane may be controlled i.e. increased, decreased or stopped as required.

In an embodiment, the passage may have a wall comprising the electroosmotic liquid transport membrane. For example the electroosmotic liquid transport membrane may form the passage. Alternatively, the electroosmotic liquid transport membrane may form one side of the passage or it may be present as one or more windows of the passage. This means that less electroosmotic liquid transport membrane can be used to form the cooling device thus making it cheaper to manufacture. In either of these two latter alternatives the passage preferably further comprises an impermeable wall, made of, e.g. an impermeable textile, which seals with the electroosmotic liquid transport membrane to form the passage. In other words, the fluid to be cooled is in direct contact with one surface of the electroosmotic liquid transport membrane.

By using the electroosmotic liquid transport membrane in the wall of the passage, heat transfer between the membrane, a surface of which is to be cooled by the evaporation of the transported liquid, and the fluid in the passage is assisted. The surface of the membrane to be cooled by the evaporation may be the surface thereof inside the passage or the opposite surface thereof, remote from the passage.

The liquid being transported to effect evaporative cooling may be transported though the electroosmotic liquid transport membrane out of the passage. In this case the fluid in the passage may be a liquid, such as water, or a gas, such as air, containing water vapour. Alternatively, when the fluid in the passage is a gas, the liquid may be transported into the passage.

When liquid is transported across the membrane out of the passage, the liquid is provided by the fluid to be cooled in the passage, such as water or a gas, such as air, containing water vapour. With this arrangement there only needs to be one fluid source to provide both the liquid to be transported and the fluid to be cooled. Cooling takes place where the liquid transported across the membrane evaporates, and can be effective to cool the membrane and hence in the passage. In one example, for cooling a building, water may be passed through the passage. Some of the water is transported across the membrane and evaporates into the ambient atmosphere, thereby cooling the water which remains in the passage. This cooled water is then diverted to inside the building to provide cooling therein. This can provide an environmentally friendly and cheap air conditioning system.

In another embodiment liquid is transported across the membrane into the passage where evaporative cooling can occur to cool the fluid in the passage. In this case, the liquid to be transported may be supplied from a fluid reservoir (liquid or moist air reservoir), on the other side of the electroosmotic liquid transport membrane, to the passage. In an example, for cooling a garment, such as a military garment, air supplied in passages in the fabric of the garment by a fan maybe cooled by the cooling device. Liquid transported across the electroosmotic liquid transport membrane from a liquid reservoir into the passage can cause cooling of the air in the passage by evaporation. Alternatively or additionally the liquid transported may be supplied by the electroosmotic liquid transport membrane being in contact with moist air such as created due to perspiration from a person wearing the cooling device.

The passage may be in direct communication with the item or environment to be cooled. Alternatively, the passage may be fluidly connected to an item or environment to be cooled which is remote from the cooling device. For example, the passage may be in fluid communication with a heat exchanger. This means that when a fluid flows through the passage and is cooled by evaporative cooling it can be transported to the heat exchanger where it can effect cooling of an environment in thermal contact with the heat exchanger.

Optionally, the cooling device can be in thermal contact with an active cooling device such as a Peltier cell or a refrigeration system. This active cooling device can be used in combination with the evaporative cooling to achieve lower temperatures when desired. This may, for example, be when insufficient cooling is achieved by evaporative cooling such as when particularly high levels of cooling are required or when the effect of evaporative cooling is limited e.g. in cold or very humid conditions.

In an exemplary embodiment, the cooling device may be used on a roof. The cooled fluid may then be transported inside the building, for example to heat exchangers to provide cooling for the building.

In a second aspect the present invention provides a cooling device, the cooling device comprising a passage for passing a cool fluid through the cooling device, and an electroosmotic liquid transport membrane arranged to transport condensation which forms on the cooling device into the cooling device.

Often when cooling devices are operated, due to being colder than their environment, condensation forms on the surface of the device. This can cause an issue if a large amount of condensation builds up or if the device is used in moisture sensitive applications such as in applications involving the cooling of electrical equipment. With the present invention, cooling can be effected whilst preventing a build up of liquid. The invention allows cooling and humidity control to be effected at the same time.

The electroosmotic liquid transport membrane may be a membrane comprising first and second conductive layers, and at least one porous layer positioned between the first and second conductive layers. In use, a voltage is applied between the first and second conductive layers to generate an electric field whereby a current passes between the conductive layers so as to induce liquid transport across the membrane. Preferably, the device comprises a power source to apply a voltage between the first and second conductive layers. The first and second conductive layers are preferably porous.

The cooling device may comprise a 3-dimensional (3D) textile which forms the passage through which a cool fluid is passed. For example, the 3D textile may comprise a pouch or textile with an inlet and outlet. The 3D textile may comprise the electroosmotic liquid transport membrane which forms at least part of the pouch. For example, the 3D textile may be formed entirely from the electroosmotic liquid transport membrane. Alternatively the 3D textile may comprise the electroosmotic liquid transport membrane as one side or as one or more windows which is(are) sealed to an impermeable textile (such as a silicon coated textile) to form the 3D textile. When the 3D textile is formed of the electroosmotic liquid transport membrane and the impermeable textile the cost of producing and running the 3D textile can be reduced.

Preferably the condensation transported by the electroosmotic liquid transport membrane is transported into the passage carrying the cool fluid. This means that there is no need to provide an additional container to collect the transported condensation and means that the condensation can be taken out of the cooling device together with the cooled fluid (after it has performed its cooling function).

The cool fluid is preferably actively cooled before being pumped into the cooling device, for example by a refrigeration system.

The electroosmotic liquid transport membrane can be controlled to control the amount of condensation transported into the cooling device. The cooling device preferably comprises a control means to effect such control. This means that the humidity at the surface can be controlled, such as being kept below a certain level. The electroosmotic liquid transport membrane may be controlled based on the output from a sensor. In an embodiment, the cooling device may comprise a humidity sensor and on the basis of the output from the humidity sensor the electroosmotic liquid transport membrane can be controlled to increase, decrease or stop the liquid transport through the membrane.

The cooling device may comprise an active cooling system such as a Peltier cell or a refrigeration system. The cooling provided by the active cooling system may be in addition to actively cooling the fluid passing through the passage at a location remote from the cooling device or may be an alternative method for cooling the fluid in the passage. The active cooling system may be controlled to ensure that sufficient levels of cooling are obtained. For example, the cooling device may comprise a temperature sensor which measures a temperature, such as at the surface of the cooling device or in the passage containing the cool fluid. The control of the active cooling system can be based on the output from the temperature sensor. This means that a target temperature can be achieved by increasing, decreasing or stopping the cooling provided by the active cooling system. The sensor for the active cooling system may be the same sensor as that used to control the liquid transport through the membrane.

The electroosmotic liquid transport membrane may be a bi-directional membrane. This means that the electroosmotic liquid transport membrane is arranged so that liquid transport can be effected to occur in either direction across the electroosmotic liquid transport membrane depending on the driving voltage applied across the membrane.

By having a bi-directional electroosmotic liquid transport membrane, liquid transport can occur into the cooling device and out of the cooling device. This means that the humidity at the surface of the cooling device can be increased and decreased. Also, if further cooling at the surface is required liquid can be transported out of the cooling device where evaporation can occur to effect evaporative cooling. The control of the bi-directional electroosmotic liquid transport membrane may be based on a sensor, such as a humidity sensor, as discussed above.

The cool fluid in the passage may be a liquid, such as water, a gas, such as air, or a combination of both.

The cooling device, which may comprise the 3D textile, can be used in beds, seats, clothing and buildings to provide cooling.

In a third aspect the present invention provides a liquid transport system, including an active membrane comprising a porous layer having conductive electrodes on the opposite surfaces arranged as to induce liquid transport across the membrane when a driving voltage is applied to said electrodes as to generate an electric field across the membrane, wherein the liquid transport system comprises a bipolar power supply connected to said electrodes such that the net direction of the liquid transport across the porous layer is bidirectional.

Preferably, the liquid transport system is part of an environment conditioning system, the environment conditioning system comprising a first environment to be conditioned and a second environment, wherein the first environment is separated from the second environment by the active membrane of the liquid transport system.

Preferably, the liquid transport system further comprises a humidity sensor and a humidity measurement unit, wherein the power supply is arranged to regulate the direction and speed of liquid flow based on an output of said humidity measurement unit.

Preferably, the active membrane includes on its surface, or is in thermal contact with, an active cooling system.

The present invention provides an air conditioning system, the air conditioning system comprising a channel through which an airstream can flow and an environment to be conditioned, and comprising a liquid transport system of the third aspect of the invention, wherein the active membrane is included in a wall of the channel.

The present invention also provides an air conditioning system, the air conditioning system comprising a liquid reservoir and an environment to be conditioned, and comprising a liquid transport system of the third aspect, wherein the active membrane of the liquid transport system is disposed between the liquid reservoir and the environment to be conditioned.

Preferably, the reservoir is formed by a textile pouch comprising a waterproof or impermeable textile and the active membrane.

The present invention provides a plaster, the plaster including the liquid transport system of the third aspect of the invention.

The present invention provides a tarpaulin for controlling the humidity of an environment enclosed by the tarpaulin, wherein the tarpaulin comprises the liquid transport system of the third aspect of the invention.

In a fourth aspect, the present invention provides a liquid transport system comprising an active membrane including a porous layer having conductive electrodes on the opposite surfaces arranged so as to induce liquid transport across the membrane when a driving voltage is applied to said electrodes so as to generate an electric field across the membrane, and a first interface layer comprising textile or fabric or other permeable structure, adjacent to the active membrane on the side of a moisture source, i.e. an upstream side.

Preferably, a surface of the active membrane which is adjacent the first interface layer is hydrophilic. More preferably, the surface of the active membrane which is adjacent the first interface layer is a metal with an oxide layer or comprises a hydrophilic coating or treatment.

Preferably, a surface of the active membrane which is adjacent the first interface layer is hydrophobic.

Preferably the liquid transport system further comprises a second interface layer comprising textile or fabric or other permeable structure adjacent to the active membrane on the side where liquid is leaving, i.e. a downstream side.

Preferably, a surface of the active membrane adjacent the second interface layer is hydrophobic.

Preferably, only a surface perpendicular to the direction of liquid transport which is adjacent the second interface layer is hydrophobic.

Preferably, the liquid transport system further comprises a second active membrane in series with the first mentioned active membrane.

Preferably, the second active membrane is more resistant to high temperatures than the first mentioned active membrane. More preferably, the first mentioned active membrane is polymer based and the second active membrane is formed from a porous fibreglass membrane.

The present invention provides a liquid transport system of the third or fourth aspect which is folded so as to constitute a hollow tube.

Preferably, the electrodes are segmented such that the active membrane may be electronically controlled to control along which segments of the membrane length liquid transport is induced.

### BRIEF DESCRIPTION OF THE DRAWINGS

The invention will be better understood with the aid of the description of an embodiment given by way of example and illustrated by the figures, in which:

FIG. 1 shows a simplified schematic representation of a membrane according to an aspect of an embodiment of the present invention.

FIG. 2 illustrates an embodiment of the present invention relating to a liquid reservoir.

FIG. 3 illustrates schematically an aspect of the present invention relating to a flexible textile pouch.

FIG. 4 illustrates a variant of the invention fifth additional interface layers.

FIG. 5 illustrates a variant of the invention including two active layers in series.

FIG. 6 illustrates schematically an embodiment of the present invention in which the active membrane and the accompanying interface membranes are folded as to form a hollow tube.

FIG. 7 illustrates an cooling device according to an embodiment of the invention.

FIG. 8 illustrates an cooling device according to another embodiment of the invention.

FIG. 9 illustrates an cooling device according to yet another embodiment of the invention.

### DETAILED DESCRIPTION OF POSSIBLE EMBODIMENTS OF THE INVENTION

### Bidirectional Flow

Membranes transporting liquid by aid of an electric field, like electroosmotic membranes or any other electro-kinetic membranes, hereafter referred to as “active membranes” will operate as long as the membrane is wet or humid. For active membranes, movable ions have to be hydrated in order to obtain moisture transport, and for membranes with a pore size allowing viscous flow a high transport rate will be obtained when the pores are filled with liquid.

In typical embodiments, such a membrane would provide uni-directional moisture transport, in order to remove excess humidity from one side of the membrane. This would normally apply to applications such as clothing, seat comfort, bed linens and tents.

However, in certain applications the possibility to transport liquid in both directions could provide unexpected and strong advantages. For a symmetric electroosmotic membrane, the direction of flow can be changed simply by changing the sign of the voltage. For instance storage containers with a stable relative humidity whatever the outside temperature can be created by associating such a bidirectional membrane with a small water reservoir, providing the ability to add or to remove humidity to the container in order to keep a constant relative humidity. This can be particularly useful for goods of high value (for instance electronic or military equipment), or perishable goods (for instance powders for the food industry or pharmaceutical applications).

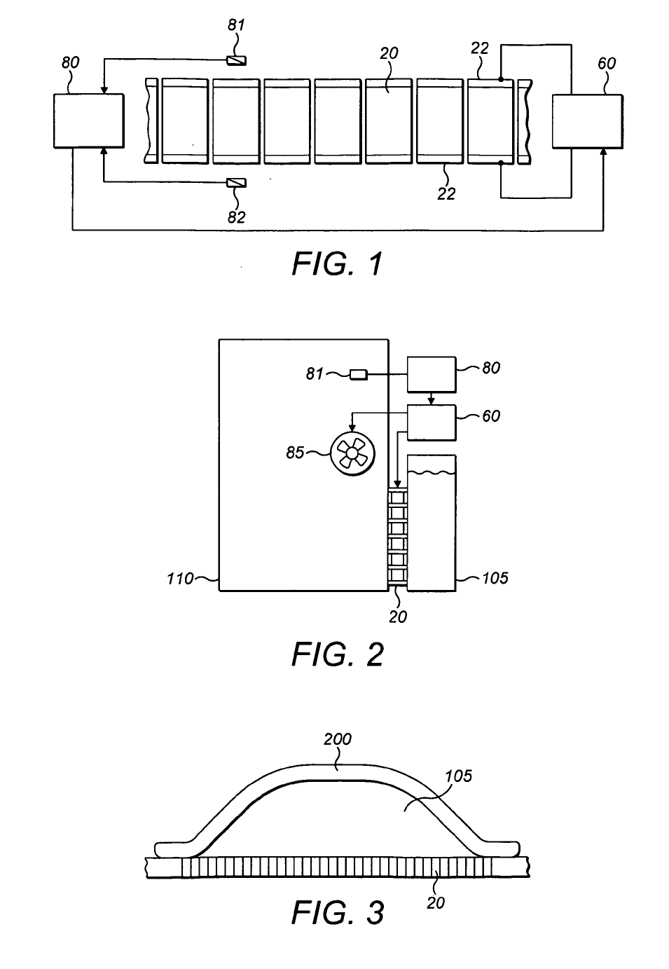

According to an embodiment of the invention, schematically represented in FIG. 1, an active liquid transport system comprises a porous membrane 20 whose opposite electrodes 22 are connected to a bipolarity power supply 60 that can provide a driving voltage having both positive or negative polarity, so as to generate an electric field across the membrane that pumps the liquid such that the net direction of liquid across the porous layer is bidirectional, that is in either of the two possible directions.

The power supply 60 could generate for example a DC voltage with selectable polarity, preferably a polarity that can be selected by an user or by an electronic controller. The direction of liquid across the membrane then inverts when the supply polarity is inverted.

In another variant, the power supply 60 could generate an AC or pulsed waveform that causes a net pumping speed across the membrane in one direction, and switch to the opposite waveform in order to cause a net pumping speed across the membrane in the other direction.

In certain applications like air conditioning systems, air with a certain level of humidity is blown through channels or tubes which are sealed from the environment. If the air is colder than the environment air on the other side of the channels or tubes, the system will provide a cooling effect. Typical applications would be in buildings, but similar systems could be used in common applications of textiles, like clothing, bed linens and seat covers. For example, W.L.Gore and Associates developed a cooling system for military uniforms based on blowing air from the outside through it by means of a fan. A similar system might be used in medical textiles e.g. to be placed inside plasters. According to a preferred inventive aspect, as it will be explained in more detail later, the active liquid transfer membrane is included in the wall of a channel that separates a cool airstream form the environment, like the inside of a garment or a tent, or a room. In other words, the active membrane may separate two environments, a first environment, which is the environment to be conditioned, and a second environment, which may be a channel through which an airstream can flow or a reservoir for water, for example.

In order to condition the air in the said applications and similar situations, the active membrane could work intermittently as a humidity dispenser or condensation removal system. Using such a membrane (instead of say a tube with a nozzle) would have the advantage of providing a high surface area for humidity exchange, resulting in fast and complete (de-) humidification or, if humidity is dispensed, an evaporative cooling effect. On the other side of the active membranes, pointing away from the airstream to be conditioned, there could be a liquid reservoir. FIG. 2 illustrates an example of an embodiment of the present invention with a liquid reservoir 105 and an active membrane 20 that is controlled by controller 80 dependent on the value of humidity measured by sensor 81 such that the hygrometry of volume 110 is maintained. An optional ventilation system 85 may promote evaporation from the membrane 20. Pure water can be used in this application. The membrane 20 may be operated to transport water from the reservoir 105 to the volume 110 to increase the humidity in the volume 110. Additionally, the membrane 20 may be operated to transport water from the volume 110 to the reservoir 105 to decrease the humidity in the volume 110.

According to another variant, in order to promote water condensation on the membrane and increase the dehumidification and air conditioning power, the membrane is placed in a point where the temperature of the membrane is relatively lower than the temperature of the volume from which water removal is desired. In a cold-protective garment, for example, the thermal insulation and thermal gradient could be engineered so as to ensure that the active membrane is slightly cooler than the air close to the body, thereby promoting condensation of vapour on the membrane.

According to another variant, the active membrane could include on its surface, or be in thermal contact with, an active cooling system, like for example a Peltier cell, or a compact refrigeration system. This arrangement could be used in breathable and air-conditioning garments for hot climates, air conditioning tents, or be used in the air conditioning of buildings, containers or any other suitable space.

In one embodiment, as seen in FIG. 3, the active membrane is flexible and the reservoir is formed by a textile pouch comprising the two layers:

a water proof or impermeable textile 200 such as polyurethane coated fabric, or an impermeable film, and

an active (e.g. electroosmotic) membrane 20.

The layers are sealed together along their rim or in certain points or along lines in a way that a space to contain the liquid reservoir 105 will be present between the two fabrics.

The active membrane could cover part of or the whole cooling surfaces of the air conditioning or cooling system.

The active membrane could also be used to exchange humidity between an airstream and the environment. For example in an air conditioning system, condensation of water along the cooled surfaces, even in standard air-conditioning applications could also create problems. By letting the active membrane constitute the outer surface, humidity could easily be removed by pumping into the airstream which transports it away. Also in this case a reversal can be effected when the humidity of the ambience is too low.

An embodiment of the present invention relates to a tarpaulin comprising an active membrane, which will not only protect structured or stored good from moisture, but could also transport moisture from the outside to the inside. The latter can be of value for materials which should not become too dry.

The bi-directional application of an active membrane is not limited to the conditioning of air, but could be used to control the humidity of soil for stability and agricultural purposes, as well as for industrial processes and drainage applications. Waste handling and compost production are other such applications.

The invention may also find uses in medical applications, like for keeping the skin at a certain humidity level.

### Membrane in a Water Distribution System

Water and moisture management active membrane may work only if the water or the vapour to be drained does effectively arrive at the membrane surface. An aspect of the present invention relates to a smart drainage system bringing water or vapour to the side of the membrane which has to be dried (an upstream side), and chasing the water away on the other side of the membrane (a downstream side).

In order to bring real advantages in applications, liquid must be transported to and/or air humidity needs to condense in the membrane, starting from the side from which moisture or humidity should be removed. For a clothing system, this would be the side of the membrane pointing towards the wearer.

The inventors have realized that the functioning of such an active membrane will strongly depend on how water or humidity is supplied to the membrane and removed from the membrane after being transported through it by the aid of an electric field.

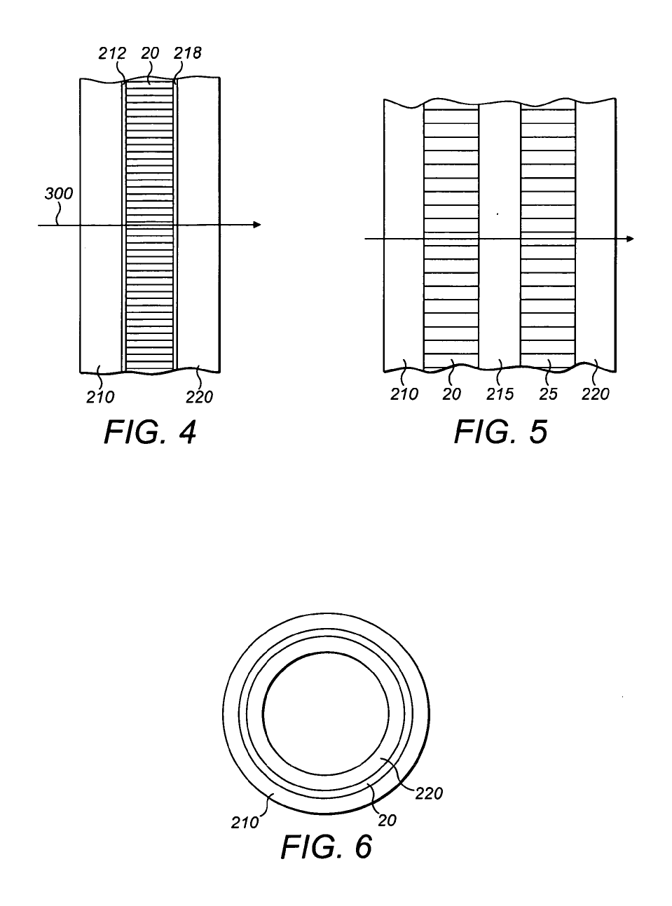

In a variant of the present invention, schematically represented in FIG. 4, the active membrane is embedded in a water transport structure, comprising different layers (textile or not) and coatings (or laminates). For conceptual purpose, the active membrane system will here be considered to consist of the following serial elements (the order follows the direction of liquid flow 300 from an upstream side to a downstream side):
1) an optional first interface layer 210 comprising textile or fabric or other permeable structure, adjacent to active membrane on the side of moisture source,
2) first surface 212 of the active membrane,
3) the porous membrane 20, preferably a dense and/or porous hydrophilic membrane,
4) second surface 218 of the active membrane, and
5) an optional second interface layer 220 comprising textile or fabric or other permeable structure adjacent to active membrane on the side where liquid is leaving.

Through experimental and theoretical study of the subject matter, the inventors have realized that specific properties are important for each of the conceptual or functional layers, as detailed in the following:

With respect to the first interface layer 210; in systems where moisture transport will be mainly in the liquid phase, the important property of this layer is good spreading of liquid by wicking, both in the normal direction towards the membrane and in the lateral direction. This way, the largest possible fraction of liquid to be removed will be in contact with the active surface at any given time. Capillary forces or gravity will bring new liquid towards the membrane when liquid is pumped away by the active membrane, and will enhance condensation, increasing the ability of the membrane to remove not only liquids but also vapours. This wicking layer 210 should at least have some hydrophilicity, but should not trap water in very small pores, inside yarn, etc, as such water would not be easily removed by the active membrane. Particularly in applications where gravity transport is important, polymer films with large pores as used towards the skin in women's sanitary towels could be used. Producers of such materials include Fibertex® (Denmark) and Mogul® (Turkey). Materials with a smaller pore size and higher hydrophilicity is usually preferred in applications such as clothing, for example non-woven wicking textile produced by the Danish company Fibertex®. Important in each case is that the matrix of the material will not retain a significant proportion of water after the capillaries have been emptied (e.g. trapped inside yarn or swelling polymer).

It has been realized that the properties of the surface 212 of active membrane pointing towards interface layer 210 (the upstream side of the membrane) strongly influence the performance of the liquid transport system of the invention. If the surface is hydrophobic, specifically more hydrophobic than interface layer 210, it will be difficult to extract water from layer 210 and transfer it to the membrane 20 for subsequent removal by electrical forces. Preferably, surface 210 is hydrophilic. Especially in the case of surfaces and metals not containing an oxide layer, like gold, that is often employed in the deposition of the electrodes 22 on the membrane 20, the adsorption of organic molecules onto the surface will modify the surface tension, usually rendering this hydrophobic. To avoid this, metals with an oxide layer, such as titanium, or with a hydrophilic coating or treatment, are preferred. Such treatments could be applied to different kind of electrodes, including conductive polymers and carbon materials. An example is a thin SiO₂ layer attached using a silane or thiol chemistry.

The above section applies to active membranes where water enters the membrane in the liquid phase. For active membranes and systems where water (or other substance) enters the membrane in the gas phase to condense in the membrane, the same does not necessarily apply. Indeed, in some embodiments a hydrophobic surface will be desired as it would avoid liquid water entering the membrane, which might be un-desired if the membrane is designed or operated to just transport clean condensates, while the liquid may contain sweat or salts etc.

On the second surface 218 of the active membrane, from whence liquid is leaving the membrane (the downstream surface of the membrane), the situation is in many ways the opposite of those at surface 212. Liquid should pass from the membrane and either run off and/or evaporate from the surface or enter a wicking layer leading the water away. It should not allow water to enter in the opposite direction too easily. Therefore, some hydrophobicity is desired for this surface. In a preferred embodiment, only the surface perpendicular to the direction of liquid transport should be hydrophobic. This way, the surface is seen as hydrophobic from a droplet on the outside, while the liquid pumped through the membrane would not have to pass through a hydrophobic barrier (requiring extra pumping pressure and thus more electric energy). In other embodiments, there can be a thin layer of hydrophobic pores to create a higher passive resistance or water proofness. Both the hydrophobicity and thickness of this section and the hydrophobicity of the outer surface should be tuned to obtain the right trade-off between water proofness from the outside and barrier for water to leave the membrane.

Hyrophobicity can be obtained by depositing a thin layer of PTFE using standard techniques.

In some cases, a second interface layer 218 adjacent to active membrane on the side where liquid is leaving is desirable. A wicking layer 218 similar to layer 210 can optionally be added to quickly remove water from the membrane surface.

According to another variant, the second interface layer 218 could present different features in order to provide, for example resistance from abrasion, shock protection, or distributing pressure loads. A garment could comprise, in different regions, active membranes having external interface layers 218 of different nature: for example, a climbing or mountaineering jacket could have a padded back layer adapted to distribute the weight of a rucksack, a snowboarding suit might present external layers with enhanced abrasion resistance on knees, and so on.

Another embodiment of the present invention relates to firefighter's garments and other protective clothing in hot environments and under high activity, where there is the danger of heat stress and even direct burns due to trapped water vapour. This variant of the invention uses a cascaded structure as represented schematically in FIG. 5. By using a first active membrane 20 for removing moisture close to the body, and a second active membrane 25 with high temperature resistance in the outer layer of the garment, an efficient system for fast liquid transport away from the body can be obtained. The active layers are separated by an intermediate layer 215 that serves to transport water and fluids and provides a measure of thermal insulation. The outer, high-temperature active membrane 25 could be realized, for example, from a porous fibreglass membrane, while the inner membrane 20 could be polymer-based.

FIG. 6 illustrates, in section and very schematically, an aspect of the invention relating to an active tubular membrane that lends itself to a number of applications. A hollow conduit comprises, in its lateral surface, an active liquid transport membrane 20 sandwiched between two interface layers 210 and 220 as described above. Single instances or webs of such membranes (i.e. a network of tubular membranes) could serve as a distributed water removal system (pumping towards the centre of the hollow fibre) and as a water distribution system when pumping in the other direction, i.e. the membrane could be a bi-directional membrane as discussed above. In both modes, water transport in the longitudinal direction of the membrane could be driven by gravity or pumps. Compared with standard tubes the active tubular membrane would have the advantage of distributing the water transport along its surface. Further, using segmented electrodes one could electronically control along which segments of the membrane length that pumping should take place.

In one embodiment the tubular membrane is a porous electroosmotic membrane with coated electrodes. In another embodiment, electrodes are not coated but provided in the form of 1) one or more metal wires running through the hollow membrane in its length direction, and 2) electrodes placed in the vicinity of the membrane. For example, using iron poles as external electrodes a low cost solution for agriculture is obtained.

For example, in agriculture, it could be used to reduce problems related to heavy rain or flooding in the water removal mode, and for irrigation in the water distribution mode.

Tubular membranes could also be used by surgeons during operations to remove fluids, and in patients who need to get body fluids drained from their intestines.

Special fibres have been developed to collect condensed water from air, any cool surface would create the same effect. Applying such surfaces on top of an active membrane constituting at least part of a sealed container, liquid could be collected to the inside of this container. This could be of relevance in dry places and places with poor access to clean water. The use of special fibres has the following advantages:

give a higher surface for evaporation, and thus facilitate fast removal of water and avoidance of liquid water,

keep the outer surface of the membrane dry, helping to maintain the membrane's passive vapour phase transport

trap the liquid in a fabric which can be disposed or regenerated. This would be of relevance for use in hospital beds and sanitary products/diapers etc. In this case the absorbent layer can also be a super absorbent textile.

Other examples of smart drainage systems include the forming of a tube by rolling a membrane, creating thus a collecting or a distribution nose, or the realization of a container with one or several pieces of the membrane, enabling the storing of the liquid to be collected or distributed.

The thickness and pore size of an active membrane (which may or may not include electrode layers) will depend on application. In typical embodiments, the membrane thickness will be in the range of 5 micrometres up to 1 millimetre, preferably between 5 and 50 micrometre, more preferably between 10 and 40 micrometres. The pore size will in most cases be between 2 nanometres and 700 nanometres, preferably between 50 and 300 nanometres.

### OTHER EMBODIMENTS

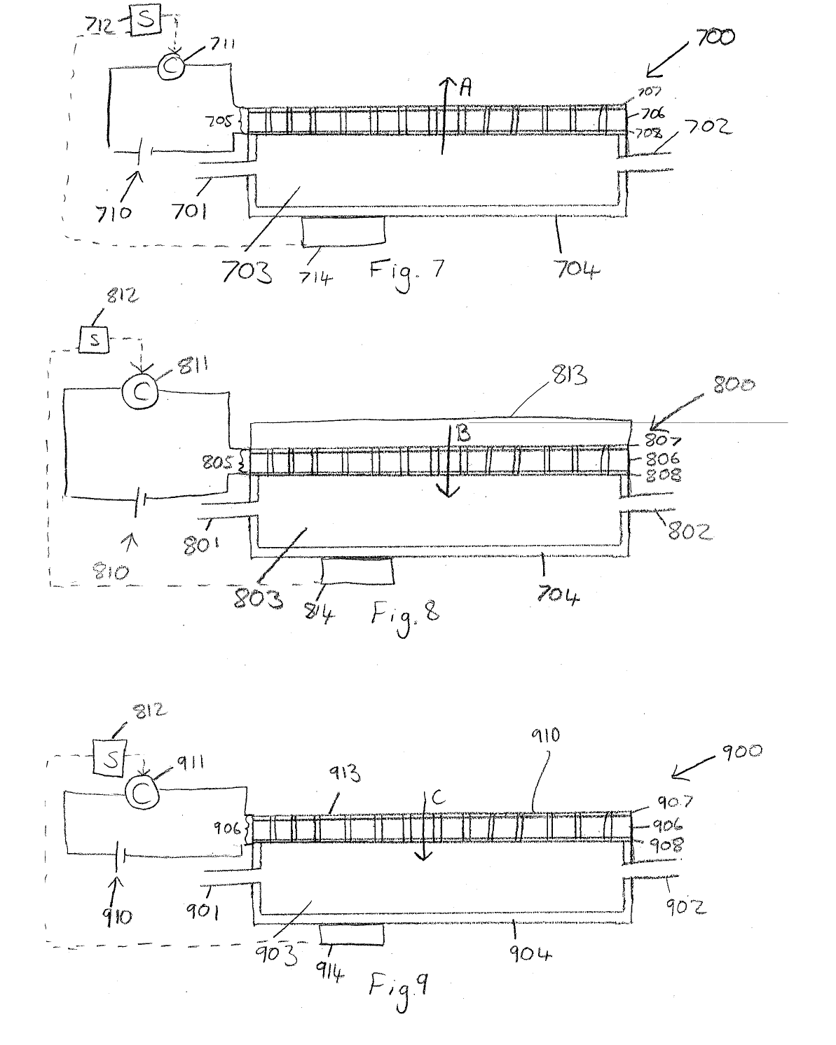

FIG. 7 shows a cooling device 700. The cooling device comprises a passage which has an inlet 701, an outlet 702 and a chamber or volume 703 disposed therebetween. The volume 703 is formed by sealing an impermeable textile 704 to an electroosmotic liquid transport membrane 705 such that the electroosmotic liquid transport membrane 705 forms one side of the volume 703.

The electroosmotic liquid transport membrane 705 has a porous layer 706 positioned between first and second conductive layers 707, 708. A voltage source 710 is arranged to be able to apply a voltage between the first and second conductive layers to generate an electric field whereby a current passes between the conductive layers so as to induce liquid transport across the membrane (in the direction of arrow A).

In use, a fluid (either water or damp air) is passed from the inlet to the outlet. A voltage is applied across the electroosmotic liquid transport membrane 705 to effect liquid transport from the fluid in the volume 703 to the surface of the electroosmotic liquid transport membrane 705 outside the volume 703. When the transported liquid reaches the surface of the electroosmotic liquid transport membrane 705 outside the volume 703 it is evaporated. The evaporation of the liquid at the surface of the electroosmotic liquid transport membrane 705 cools the electroosmotic liquid transport membrane 705 and the fluid passing through the volume 703. The cooled fluid is then transported to a location where it is used to effect cooling.

Similarly to FIG. 7, FIG. 8 shows a cooling device 800. The cooling device comprises a passage which has an inlet 801, an outlet 802 and a chamber or volume 803 disposed therebetween. The volume 803 is formed by sealing an impermeable textile 804 to an electroosmotic liquid transport membrane 805 such that the electroosmotic liquid transport membrane 805 forms one side of the volume 803. The electroosmotic liquid transport membrane 805 is in contact with a reservoir 813.

The electroosmotic liquid transport membrane 805 has a porous layer 806 positioned between first and second conductive layers 807, 808. A voltage source (not shown) is arranged to be able to apply a voltage between the first and second conductive layers to generate an electric field whereby a current passes between the conductive layers so as to induce liquid transport across the membrane (in the direction of arrow B).

In use, air is passed from the inlet 801 to the outlet 802 through the volume 803. A voltage is applied across the electroosmotic liquid transport membrane 805 to effect liquid transport from the reservoir 813 to the surface of the electroosmotic liquid transport membrane 805 inside the volume 803. When the transported liquid reaches the surface of the electroosmotic liquid transport membrane 705 it is evaporated into the air inside the volume 803. The evaporation of the liquid at the surface of the electroosmotic liquid transport membrane 805 cools the air passing through the volume 803. The cooled air is then used to effect cooling.

FIG. 9 shows a cooling device 900 comprising a electroosmotic liquid transport membrane 905. The cooling device comprises a passage which has an inlet 901, an outlet 902 and a chamber or volume 903 disposed therebetween. The volume 903 is formed by sealing an impermeable textile 904 to an electroosmotic liquid transport membrane 905 such that the electroosmotic liquid transport membrane 905 forms one side of the volume 903.

The electroosmotic liquid transport membrane 905 has a porous layer 906 positioned between first and second conductive layers 907, 908. A voltage source (not shown) is arranged to be able to apply a voltage between the first and second conductive layers 907, 908 to generate an electric field whereby a current passes between the conductive layers so as to induce liquid transport across the membrane 905 (in the direction of arrow C). The first conductive layer 907 forms an outer surface 913 of the cooling device.

In use, fluid which has been cooled before passing into the inlet 901 is passed through the volume 903 to the outlet 902. The cooled fluid in volume 903 cools the environment around the cooling device 900 which results in condensation forming on the surface 913 of the cooling device 900. A voltage is applied across the electroosmotic liquid transport membrane 905 to effect liquid transport from the surface 913, exposed to the environment outside the volume 903, to the surface of the electroosmotic liquid transport membrane 905 inside the volume 903. This moves condensation from the surface 913 of the cooling device 900 into the volume so that the surface of the cooling device may be kept dry.

In all of the embodiments shown in FIGS. 7, 8 and 9, the cooling devices 700, 800, 900 can optionally comprise a control unit 711, 811, 911 and a sensor 712, 812, 912, such as a humidity sensor or a temperature sensor. The control unit 711, 811, 911 can control the voltage applied to the electroosmotic liquid transport membrane 705, 805, 905 based on the output from the sensor 712, 812, 912.

Additionally, in all of the embodiments shown in FIGS. 7, 8 and 9, the cooling devices 700, 800, 900 can optionally comprise an active cooling system 714, 814, 914 such as a Peltier cell or a refrigeration system. If the cooling device has a control unit 711, 811, 911 and a sensor 712, 812, 912 the active cooling system 714, 814, 914 can be controlled on the basis of the output from the sensor.

1-5. (canceled)

6. A cooling device as claimed in claim 45, wherein the electroosmotic liquid transport membrane comprises first and second conductive layers, and at least one porous layer positioned between the first and second conductive layers.

7. A cooling device as claimed in claim 45, wherein the device comprises a power source to apply a voltage to the electroosmotic liquid transport membrane to effect liquid transport.

8. A cooling device as claimed in claim 45, wherein the device comprises a control means for controlling the liquid transport through the membrane and wherein the device comprises a sensor and wherein the output of the sensor is used to control the transport of liquid through the electroosmotic liquid transport membrane.

9. (canceled)

10. A cooling device as claimed in claim 45, wherein the passage is connected to an item or environment to be cooled which is remote from the cooling device.

11. A cooling device as claimed in claim 45, wherein the device comprises an active cooling device.

12. A cooling device, the cooling device comprising:
a passage for passing a cool fluid through the cooling device; and
an electroosmotic liquid transport membrane arranged to transport condensation which forms on the cooling device into the cooling device.

13. A cooling device as claimed in claim 12, arranged so that in use the condensation transported by the electroosmotic liquid transport membrane is transported into the passage carrying the cool fluid.

14. A cooling device as claimed in claim 12, wherein the electroosmotic liquid transport membrane forms at least part of the passage.

15. (canceled)

16. A cooling device as claimed in claim 12, wherein the cooling device comprises a control means to control the amount of condensation transported into the cooling device, and comprising a sensor for the active cooling system and wherein the active cooling system is controlled based on an output from the active cooling system sensor.

17. (canceled)

18. A cooling device as claimed in claim 12, further comprising an active cooling system for cooling the cool fluid before it is passed through the passage of the cooling device.

19-20. (canceled)

21. A cooling device as claimed in claim 12, wherein the device comprises a power source to apply a voltage to the electroosmotic liquid transport membrane to effect liquid transport.

22. A cooling device as claimed in claim 21, wherein the power source is bipolar so that the electroosmotic liquid transport membrane is a bi-directional membrane, wherein liquid transport can be effected to occur in either direction across the electroosmotic liquid transport membrane depending on the driving voltage applied across the membrane.

23. A cooling device as claimed in claim 21, wherein the power source is unipolar so that the electroosmotic liquid transport membrane is a uni-directional membrane, wherein liquid transport can be effected to occur in only one direction across the electroosmotic liquid transport membrane.

24-44. (canceled)

45. A cooling device, wherein the cooling device comprises:
an electroosmotic liquid transport membrane; and
a passage through which a fluid to be cooled can flow, the passage having a wall comprising the electroosmotic liquid transport membrane;
wherein the electroosmotic liquid transport membrane is arranged to transport liquid to effect evaporative cooling such that the fluid in the passage can be cooled, and wherein the fluid in the passage is a liquid and wherein the cooling device is arranged so that in use the liquid being transported to effect evaporative cooling is transported though the electroosmotic liquid transport membrane out of the passage.

46. A cooling device, wherein the cooling device comprises:
an electroosmotic liquid transport membrane; and
a passage through which a fluid to be cooled can flow, the passage having a wall comprising the electroosmotic liquid transport membrane;
wherein the electroosmotic liquid transport membrane is arranged to transport liquid to effect evaporative cooling such that the fluid in the passage can be cooled, wherein the fluid in the passage comprises a gas, wherein in use the liquid being transported to effect evaporative cooling is transported though the electroosmotic liquid transport membrane into the passage, and wherein the cooling device comprises a fluid reservoir for containing liquid to be transported to the passage.

47. A cooling device as claimed in claim 46, wherein the electroosmotic liquid transport membrane comprises first and second conductive layers, and at least one porous layer positioned between the first and second conductive layers.

48. A cooling device as claimed in claim 46, wherein the device comprises a power source to apply a voltage to the electroosmotic liquid transport membrane to effect liquid transport.

49. A cooling device as claimed in claim 46, wherein the device comprises a control means for controlling the liquid transport through the membrane, wherein the device comprises a sensor and wherein the output of the sensor is used to control the transport of liquid through the electroosmotic liquid transport membrane.

50. A cooling device as claimed in claim 46, wherein the passage is connected to an item or environment to be cooled which is remote from the cooling device.

51. A cooling device as claimed in claim 46, wherein the device comprises an active cooling device.
